(19) United States
(12) Patent Application Publication
(10) Pub. No.: US 2011/0104387 A1
(43) Pub. Date: May 5, 2011

(54) METHOD OF COLD PLASMA SURFACE PROCESS FOR FERROUS ABSORBENT

(76) Inventors: Meng-Tan Chiang, Bade City (TW); Cheng-Hsiang Chuang, Bade City (TW); Jenq-Der Tsou, Guanxi Township (TW); Ko-Shao Chen, Taipei City (TW); Shu-Ju Chang, Dayuan Township (TW); Shu-Chuan Liao, Guishan Township (TW)

(21) Appl. No.: 12/612,618

(22) Filed: Nov. 4, 2009

(51) Int. Cl. C08J 7/18

(52) U.S. Cl. 427/489

(57) ABSTRACT

The invention provides a method of a cold plasma surface process for ferrous absorbent including the following steps. Firstly, a substrate is disposed in a vacuum chamber under a room temperature, and electrical energy is transmitted to the substrate; next, organic silicon monomer is added into the vacuum chamber under the room temperature; at last, the organic silicon monomer is deposited on the surface of the substrate by a plasma polymerization process to form a hydrophobic film on the surface of the substrate.

### BACKGROUND OF THE INVENTION

1. Field of the Invention

This invention relates to a method of surface process for ferrous absorbent and more particularly relates to a method of cold plasma surface process for ferrous absorbent of coating with organic protection film under room temperature by a plasma polymerization process.

2. Description of the Prior Art

With the development of technology, people have pay attention to the problem of electromagnetic wave induced by electronic products, even at law. In the methods for preventing contamination of electromagnetic wave, ferrous absorbent is a wide-used material for preventing contamination currently.

The surface of the powder of ferrous absorbent tends to oxidization to be eroded because of external environment conditions, such as humidity, strong acid, and strong alkali. However, the erosion on the surface of the powder of ferrous absorbent leads to the influence of the characteristic of absorbing electromagnetic wave and the reduction of the efficiency of absorbing electromagnetic wave. Therefore, it is always one of the emphasized developments in the associated fields to improve the ability of anti-oxidation and corrosion resistance of the surface of the powder of ferrous absorbent.

In general, the method in the prior art for preventing the surface of the powder of ferrous absorbent from being eroded includes: electroplating, sol-gel, solution polymerization, diffusion process, chemical vapor deposition (CVD), and so on. However, the above methods respectively have defects to be overcome, which are described in the following.

In the method of electroplating, the powder of ferrous absorbent is coated with a protection film of alloy of Cu, Ni, and so on, which makes the total weight of the powder of ferrous absorbent increase and is disadvantageous to production of the powder of ferrous absorbent. Besides, the retrieval of the electroplating waste solution is also a problem associated with environmental protection.

In the method of sol-gel, the powder of ferrous absorbent is immersed into solution of silicon compound and is heated to absorb SiO₂ to form a protection film on the surface thereof. In the heating-sintering reaction, the method of sol-gel tends to inducing aggregation on the powder of ferrous absorbent. When the temperature of heating is beyond 400 degrees in Celsius, the oxidization of the powder of ferrous absorbent is accelerated so as to reduce the ability of absorbing electromagnetic wave.

In the method of solution polymerization, the powder of the ferrous absorbent is uniformly mixed with polymer monomer and then dried to coat the powder of ferrous absorbent with the polymer monomer. The defects of this method lie on the uneasy control of the uniformity of the coated protection (polymer monomer), the requirement for multiple polymerization processes, and high cost.

In the method of diffusion process, inert gas is heated under the range of from 1350 degrees to 1650 degrees in Fahrenheit to diffuse so as to form small powder. The method still has the defects of the uneasy control of the uniformity of the silicon compound protection film and the requirement of high-temperature process which leads to high cost and time waste.

The method of CVD for anticorrosion is to coat the surface of the powder of ferrous absorbent with two protection films of Al₂O₃ respectively by different thickness. The method still has the disadvantages of uneasily controlling the uniformity of the Al₂O₃ protection films, high cost, and time waste.

### SUMMARY OF THE INVENTION

Accordingly, the first scope of the invention is to provide a method of cold plasma surface process for ferrous absorbent. The method uses a plasma polymerization process under room temperature to make the surface of the powder of ferrous absorbent absorb organic silicon to form a protection film, so as to solve the problems of the prior art.

According to an embodiment, the method of cold plasma surface process for ferrous absorbent of the invention includes the following steps of: (a) disposing a substrate at a vacuum chamber under a room temperature and transmitting an electric energy into the substrate; (b) transporting organic silicon monomer into the vacuum chamber under the room temperature; and (c) forming a hydrophobic film by depositing the organic silicon monomer on a surface of the substrate by use of a plasma polymerization process.

As discussed above, the method of cold plasma surface process for ferrous absorbent of the invention is to perform the surface process on the powder of ferrous absorbent by use of the plasma polymerization process. The method could perform the plasma polymerization process under a room temperature to make the surface of the powder of ferrous absorbent absorb the organic silicon to form the protection film so as to be isolated from air, water or others and maintain the characteristic of the ferrous absorbent. In addition, the invention could improve the dispersibility of the powder of ferrous absorbent and the compatibility with polymeric cement and further raise the convenience and the efficiency of mixing.

The advantage and spirit of the invention may be understood by the following recitations together with the appended drawings.

### BRIEF DESCRIPTION OF THE APPENDED DRAWINGS

FIG. 1A is a flow chart illustrating a method of cold plasma surface process for ferrous absorbent according to an embodiment of the invention.

FIG. 1B is a detailed flow chart of the step S24 in FIG. 1A.

FIG. 2 is a schematic diagram illustrating the path of the plasma polymerization process.

FIG. 3 is a schematic diagram illustrating the mechanism of the plasma polymerization.

FIG. 4 is a schematic diagram illustrating the contact angles between water drops and the surface of the substrate for different plasma processes.

FIG. 5 is a measurement curve diagram of absorbing electromagnetic wave by the powder of ferrous absorbent.

### DETAILED DESCRIPTION OF THE INVENTION

The invention provides a method of cold plasma surface process for ferrous absorbent. The method could perform a surface modification on the powder of ferrous absorbent by use of a plasma polymerization process under a room temperature, so as to improve the adhesion of the organic silicon protection film to the ferrous absorbent.

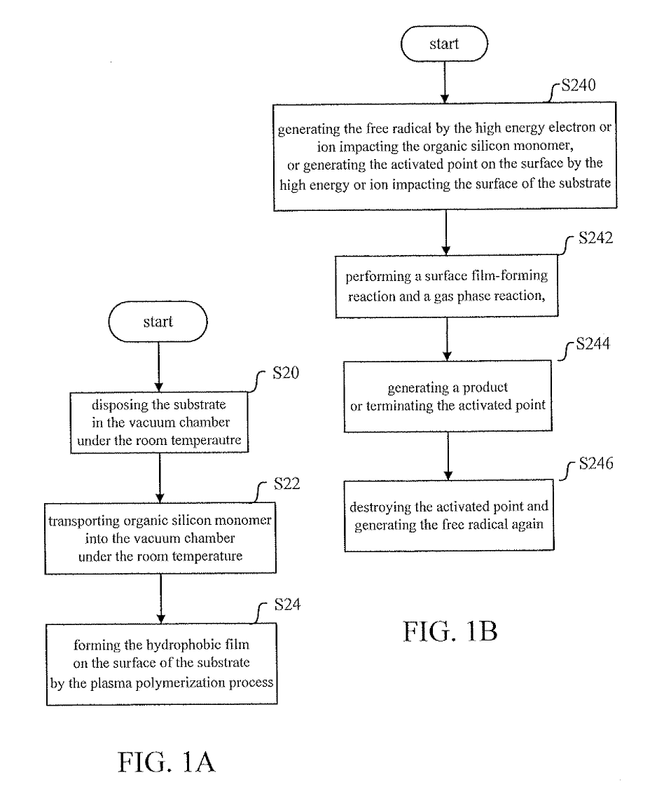

Please refer to FIG. 1A. FIG. 1A is a flow chart illustrating the method of cold plasma surface process for ferrous absorbent according to an embodiment of the invention. As shown in FIG. 1A, first, the step S20 is performed to dispose a substrate at a vacuum chamber under a room temperature and transmit an electric energy into the substrate. Therein, the vacuity of the vacuum chamber is between 0.01 torr and 0.4 torr, and the power of the electric energy of the plasma polymerization process is between 10 watts and 150 watts.

In practical applications, plasma is a common method of surface modification for material. It is often classified into two kinds of hot plasma and cold plasma. The hot plasma is performed by discharging under a high temperature (about 60000K) to excite molecules of the system to be ions. The technique of the cold plasma the invention invokes is performed by discharging in a low pressure system (about 10˜400 mtorr) so as to make the molecules of the system form plasma. The technique of the cold plasma is performed by use of activating process with plasma to form films which has the advantages of low-temperature deposition, good coverage, and no matter whether the substrate is conductive or not, so that the substrate could be provided with being coated with uniform and well-adhered organic film with few cavities.

The substrate is powder of ferrous absorbent. In practical applications, the powder of ferrous absorbent could include iron powder, ferrous alloy powder, carbonyl iron powder, polycrystalline iron fiber, or ferrite; however, the invention is not limited to this.

Then, the step S22 is performed to transporting organic silicon monomer into the vacuum chamber under the room temperature. In the embodiment, the organic monomer could be fat or cyclic organic methylsilazane. Therein, the methylsilazan could be hexamethyldisilazane (HMDSZ) and so on; however, the invention is not limited to this.

At last, the step S24 is performed to deposit the organic silicon monomer on the surface of the substrate by use of a plasma polymerization process to form a hydrophobic film thereon. In practice, the thickness of the hydrophobic film is between 1 nano-meter and 1000 nano-meters.

Please refer to FIG. 1B. FIG. 1B is a detailed flow chart of the step S24 in FIG. 1A. As shown in FIG. 1B, the plasma polymerization process includes the following steps. First, the step S240 is performed by generating a free radical by a high energy electron or an ion impacting the organic silicon monomer or generating an activated point on the surface by the high energy or the ion impacting the surface of the substrate. The step S240 could therefore be regarded as initiation reaction.

Then, the step S242 is performed by performing a surface film-forming reaction and a gas phase reaction. Therein, the surface film-forming reaction is to react with the free radical or to absorb the organic silicon monomer, and the gas phase reaction is to combine with the free radical or the organic silicon monomer. The step S242 could therefore be regarded as propagation reaction.

Afterward, the step S244 is performed by generating a product by the surface film-forming reaction and the gas phase reaction or terminating the activated point on the surface of the substrate by the surface film-forming reaction and the gas phase reaction. The step S244 could therefore be regarded as termination reaction. At last, the step S246 is performed by destroying the activated point and generating the free radical again, and at the same time, accelerated electrons and ultraviolet ray activate the polymeric monomer on the surface. The step S246 could therefore be regarded as reinitiation reaction.

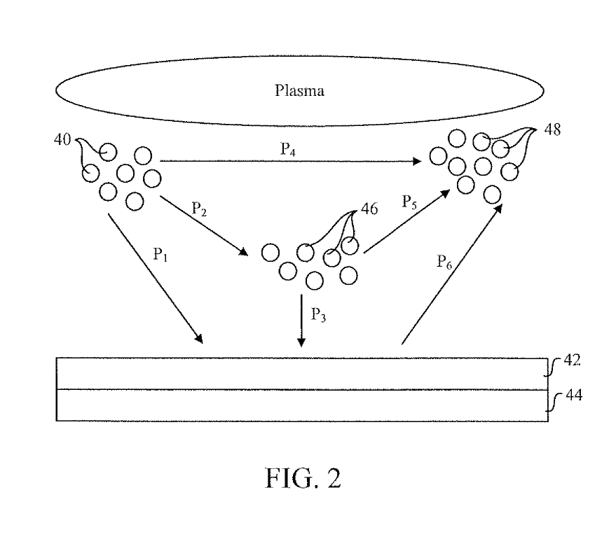

Please refer to FIG. 2. FIG. 2 is a schematic diagram illustrating the path of the plasma polymerization process. As shown in FIG. 2, the silicon monomer 40 is involved in the gas phase reaction along the path P₁ so that the silicon polymeric film 42 is formed on the surface of the substrate 44. At the same time, the silicon monomer 40 is also transformed into the reactive reaction product 46 along the path P₂ or into the non-reaction product 48 along the path P₄. The reactive reaction product 46 could be deposited on the surface of the substrate 44 along the path P₃ to form the silicon polymeric film 42 or transformed into the non-reaction product 48 along the path P₅. In practical applications, the silicon polymeric film 42 could also be transformed into the non-reaction product 48 along the path P₆ and then exhausts out of the system.

The plasma polymerization process includes homogeneous polymerization reaction and film-surface non-homogeneous polymerization reaction. The polymerization of the silicon monomer to the silicon polymeric film 42 along the path P₁ classified to primary molecule polymerization process. Normally, the initial organic silicon monomer has a structure with functional group for polymerization (e.g. double bond and triple bond). The polymerization process is regards as plasma induced polymerization.

The reactions along the paths P2 and P3 would form various intermediate products (e.g. free radical, ion, and molecule) so that the organic silicon monomer could not be preserved effectively. In practice, the reaction is also regarded as plasma polymerization, without requirement for the existence of the structure with functional group for polymerization. The plasma polymerization would produce different product according to different plasma parameters. The deposition rate is relative to the power of plasma, the flow of monomer, and the molecular weight of monomer.

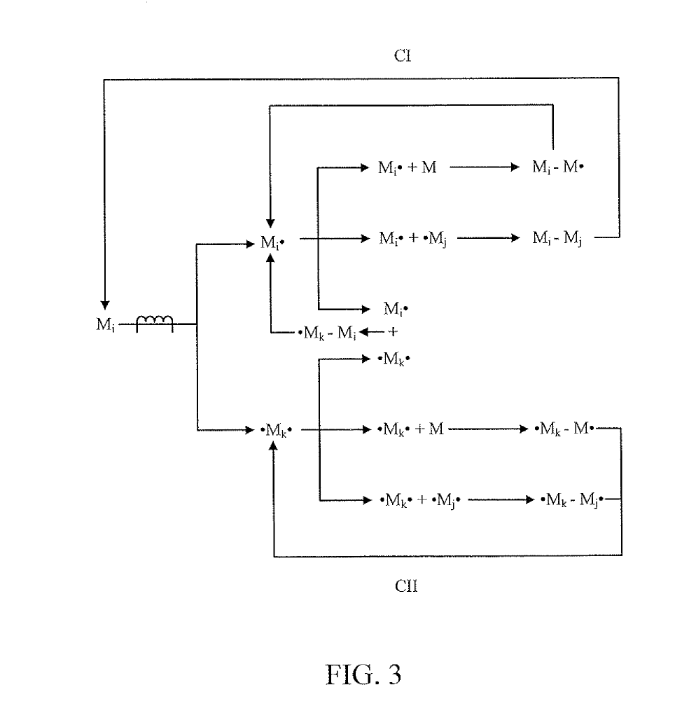

In general, plasma polymerization is classified to atomic polymerization and involves impacts between various particles (e.g. electron and atom, atom and ion). These particles react with the surface of the substrate or the wall of the chamber. Please refer to FIG. 3. FIG. 3 is a schematic diagram illustrating the mechanism of the plasma polymerization. As shown in FIG. 3, M. presents a free radical or an electric ion. A single functional activated group M. and a bi-functional activated group .M. are generated the monomer impacting electrons in the plasma. The single functional activated group M. and the bi-functional activated .M. respectively form a first cycle CI (mono-functional activated species) and a second cycle CII (bi-functional activated species). The first cycle CI and the second cycle CII are combined by cross-cycle reaction. Generally speaking, the reaction mechanism of the plasma polymerization for saturated monomer is determined by the first cycle CI, while the reaction mechanism of the plasma polymerization for unsaturated monomer (e.g. double bond and aromatic) which tends to form multi-functional activated material is determined by the second cycle CII.

In the following, a practical application of the invention is illustrated with the example of monomer of perfluoromethyl cyclohexane (PFMCH) or HMDSZ according to the above steps (S20˜S24). Iron chips or powder of ferrous absorbent are disposed on the electrode in the plasma reaction apparatus. Next, the plasma reaction apparatus is vacuumed to arrive at a vacuity between 0.01 torr and 0.03 torr. Then, argon is transported in for activation process on the surface of the substrate (the process takes about 1 minute, and the work power is about 40 watts).

When the activation process on the surface of the substrate is completed, the vacuum process is performed again to arrive at a vacuity between 0.01 torr and 0.05 torr. Then, monomer of PFMCH and HMDSZ is transported in. The reaction time for the stage is about 5 minutes to 20 minutes, and the work power is between 30 watts and 40 watts. The process of coating the surface of the powder of ferrous absorbent with protection film is therefore completed.

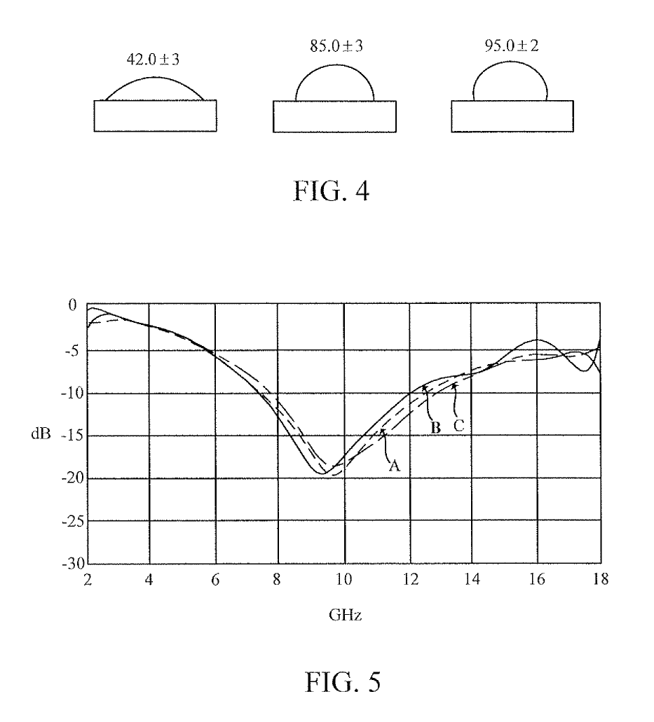

In fact, if the surface of the substrate is not processed with plasma, the hydrophobic angle thereof is 42.0±3°. If the surface of the substrate is processed with plasma of PFMCH and HMDSZ, a hydrophobic film is formed thereon so that the hydrophobic angle for the case of depositing with PFMCH is 85.0±3° and the hydrophobic angle for the case of depositing with HMDSZ is 95.0±2°, as shown in FIG. 4.

Furthermore, if the powder of ferrous absorbent without being processed and the powder of ferrous absorbent with being processed with surface coating of PFMCH and HMDSZ are mixed uniformly in deionized water for at least two months, it could be found that the powder of ferrous absorbent processed with HMDSZ is indeed prevented from being eroded.

Please refer to FIG. 5. FIG. 5 is a measurement curve diagram of absorbing electromagnetic wave by the powder of ferrous absorbent. As shown in FIG. 5, it shows the return loss (dB), which is measured in free space on the basis of AUS MIL-A-17161, of absorbing chips made of the powder of ferrous absorbent without being processed (the curve A), the powder of ferrous absorbent coated with HMDSZ (the curve B), and the powder of ferrous absorbent coated with HMDSZ which is immersed in deionized water for at least two months (the curve C). The characteristics of the absorbing chips made of the powder of ferrous absorbent coated with HMDSZ and the absorbing chips made of the powder of ferrous absorbent coated with HMDSZ which is immersed in deionized water for at least two months are similar, which shows that the process of HMDSZ plasma indeed could protect the powder of ferrous absorbent and the characteristic thereof is not influenced.

In practical applications, the invention could provide the powder of ferrous absorbent coated with organic silicon monomer. When it is required to make absorbing chips or other devices, the powder of ferrous absorbent coated with organic silicon monomer could be mixed with other material in a mold to then make required casings or members.

Compared with the prior art, the method of cold plasma process for ferrous absorbent of the invention is to process the surface of the powder of ferrous absorbent by the plasma polymerization process. The method could perform the plasma polymerization process under the room temperature to make the organic protection film adhered on the surface of the powder of ferrous absorbent so that the powder is isolated form air, water, or other materials and the characteristic of the ferrous absorbent is not influenced, even diminished. In addition, the invention could improve the dispersibility of the powder of ferrous absorbent and the compatibility with polymeric cement and further raise the convenience and the efficiency of mixing.

With the example and explanations above, the features and spirits of the invention will be hopefully well described. Those skilled in the art will readily observe that numerous modifications and alterations of the device may be made while retaining the features and spirit of the invention. Accordingly, the above disclosure should be construed as limited only by the metes and bounds of the appended claims.

What is claimed is:

1. A method of cold plasma process for ferrous absorbent, said method comprising the following steps of:
(a) disposing a substrate at a vacuum chamber under a room temperature and transmitting an electric energy into the substrate;
(b) transporting organic silicon monomer into the vacuum chamber under the room temperature; and
(c) forming a hydrophobic film by depositing the organic silicon monomer on a surface of the substrate by use of a plasma polymerization process.

2. The method of claim 1, wherein the substrate is powder of ferrous absorbent.

3. The method of claim 2, wherein the powder of ferrous absorbent is iron powder, ferrous alloy powder, carbonyl iron powder, polycrystalline iron fiber, or ferrite.

4. The method of claim 1, wherein the step (c) comprises the following steps of:
(c1) generating a free radical by a high energy electron or an ion impacting the organic silicon monomer, or generating an activated point on the surface by the high energy or the ion impacting the surface of the substrate;
(c2) performing a surface film-forming reaction and a gas phase reaction, wherein the surface film-forming reaction is to react with the free radical or to absorb the organic silicon monomer, and the gas phase reaction is to combine with the free radical or the organic silicon monomer;
(c3) generating a product by the surface film-forming reaction and the gas phase reaction, or terminating the activated point on the surface of the substrate by the surface film-forming reaction and the gas phase reaction; and
(c4) destroying the activated point and generating the free radical again.

5. The method of claim 4, wherein the product is the hydrophobic film formed on the surface of the substrate.

6. The method of claim 1, wherein a reaction time of the plasma polymerization process is between 1 minute and 100 minutes.

7. The method of claim 1, wherein a power of the electric energy of the plasma polymerization process is between 10 watts and 150 watts.

8. The method of claim 1, wherein a vacuity of the vacuum chamber is between 0.01 torr and 0.4 torr.

9. The method of claim 1, wherein a thickness of the hydrophobic film is between 1 nano-meter and 1000 nano-meters.

10. The method of claim 1, wherein the organic silicon monomer is fat or cyclic organic methylsilazane.
